(19) United States
(12) Patent Application Publication
(10) Pub. No.: US 2025/0195316 A1
(43) Pub. Date: Jun. 19, 2025

(54) INFLATABLE MYOFASCIAL RELEASE DEVICE

(71) Applicant: John Covington, Herrin, IL (US)

(72) Inventor: John Covington, Herrin, IL (US)

(21) Appl. No.: 18/543,412

(22) Filed: Dec. 18, 2023

(51) Int. Cl. A61H 9/00

(52) U.S. Cl. CPC A61H 9/0092; A61H 2201/1253; A61H 2201/1685; A61H 2201/1695

(57) ABSTRACT

An inflatable myofascial release device capable of being placed at select desired points to apply pressure to specific regions of a user's body to alleviate tissue aches and pains from myofascial tissue pain. An inflatable bladder is positioned centrally on an elongated strap and includes an attached and squeezable hand pump for inflation. The device includes a pouch adjacent the inflatable bladder that removably receives a spherical pressure applicator. In operation, the user inserts a desired spherical pressure applicator into the pouch. The user then secures the elongated strap around his body such that the strap extends across an area where muscle release is desired. The user then inflates the inflatable bladder to apply additional pressure against his body. In this way, the user customizes positioning, size of the pressure applicator, and overall pressure applied by the device to achieve a desired level of myofascial release.

### BACKGROUND OF THE INVENTION

The present invention relates to a muscle release device. More particularly, the present invention provides an inflatable myofascial release device.

Some people deal with chronic aches and pains in different parts of their body. It is often difficult for those people to obtain the necessary relief needed to function without experiencing pain.

Specifically, myofascial tissue pain may be incredibly frustrating and difficult to deal with. Myofascial tissue is a thin casing of connective tissue that surrounds and holds a muscle in place. Due to the high number of nerves that myofascial tissue possesses, the tissue is hypersensitive, meaning that any movement of the muscles that the damaged or injured myofascial tissue is connected to will result in relatively high levels of pain.

The currently available methods of standard medication and pain medication may not provide the necessary relief for individuals for a prolonged amount of time. For most individuals to receive the relief that they need, they have to seek medical treatment for the myofascial tissue pain they are experiencing. Seeking such medical treatment for myofascial tissue pain may be expensive.

In order to address these concerns, the present invention will provide users with an inflatable myofascial release device capable of being placed at select desired points on a user's body to apply pressure to specific regions to alleviate tissue aches and pains from myofascial tissue pain.

### SUMMARY OF THE INVENTION

In view of the foregoing disadvantages inherent in the types of inflatable myofascial release devices and similar devices now present in the known art, the present invention provides an inflatable myofascial release device that is capable of being placed at select desired points on a user's body to apply pressure to specific regions to alleviate tissue aches and pains from myofascial tissue pain.

In one embodiment, the inflatable myofascial release device includes an elongated strap having a fastener disposed on each opposing end of the elongated strap, an inflatable bladder centrally positioned on the elongated strap, a pouch disposed adjacent to the inflatable bladder, a pair of ancillary straps running perpendicular to the elongated strap, the pair of ancillary straps include a first ancillary strap and a second ancillary strap that create pressure around the inflatable bladder, and a removable spherical pressure applicator composed of a rigid spherical body and a bendable sheet, wherein the pouch receives and contains the removable spherical pressure applicator.

One object of the present invention is to provide an inflatable myofascial release device that provides relief for Myofascial pain syndrome or MPS and fibromyalgia.

Another object of the present invention is to provide an inflatable myofascial release device that replaces the need for relatively more expensive and complicated myofascial tissue pain treatments.

Another object of the present invention is to provide an inflatable myofascial release device that is a relatively quick and easy treatment for myofascial tissue pain treatments.

Another object of the present invention is to provide an inflatable myofascial release device that utilizes relatively simple parts and components to receive substantial quick relief from myofascial tissue pain.

Other objects, features, and advantages of the present invention will become apparent from the following description taken in conjunction with the accompanying figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top view of an unassembled embodiment of an inflatable myofascial release device.

FIG. 2 shows a top view of an assembled embodiment of an inflatable myofascial release device.

FIG. 3 shows a top view of an alternative assembled embodiment of an inflatable myofascial release device.

### DETAILED DESCRIPTION OF THE INVENTION

Reference is made herein to the attached figures. For the purposes of presenting a brief and clear description of the present invention, the preferred embodiment will be discussed as used for providing an inflatable myofascial release device 100. The figures are intended for representative purposes only and should not be considered to be limiting in any respect.

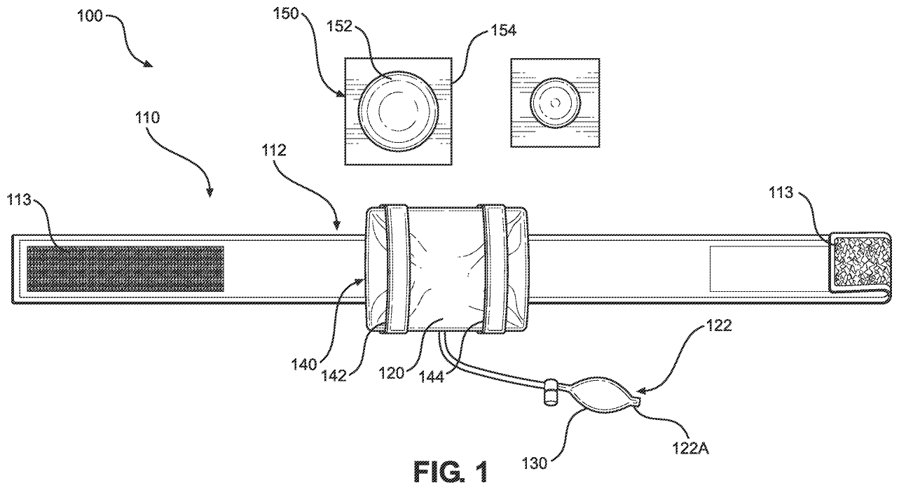

Referring now to FIG. 1 there is shown a topview of an unassembled embodiment of an inflatable myofascial release device 100.

The inflatable myofascial release device 100 may comprise an elongated strap 110 and an inflatable bladder 120.

The elongated strap 110 may include a fastener 112 disposed on each opposing end of the elongated strap 110. The fastener 112 may be adapted to allow the elongated strap 110 to be adjustably secured around a desired area of a user's body. In one embodiment, the fastener 112 may include a hook and loop fastener or VELCRO® fastener 113 disposed on opposing ends of the elongated strap 110. The VELCRO® fastener 113 may be adapted to selectively engage and disengage about the user's body or the like.

The inflatable bladder 120 may be centrally positioned on the elongated strap 110. The inflatable bladder 120 may include an attached and squeezable hand pump 122 or an attached and squeezable foot pump 122A to inflate the inflatable bladder 120. The inflatable bladder 120 may include a plurality of additional elongated straps 110 (not shown) for anatomical needs for counter pressure when used in other areas of the user's body.

The inflatable myofascial release device 100 may further include a pouch 130. The pouch 130 may be adjacent to the inflatable bladder 120. A pair of ancillary straps 140 may run perpendicular to the elongated strap 110. A first ancillary strap 142 may be disposed across a first side of the inflatable bladder 120 and a second ancillary strap 144 may be disposed across a second side of the inflatable bladder 120. The pair of ancillary straps 140 may create pressure around the inflatable bladder 120 and secure the inflatable bladder 120 in the desired location. The inflatable bladder 120 may include a plurality of additional ancillary straps 140 (not shown) for anatomical needs for counter pressure when used in other areas of the user's body or the like. The inflatable myofascial release device 100 may also include a removable spherical pressure applicator 150. The removable spherical pressure applicator 150 may be composed of a rigid spherical body 152 or any geometrical shape. The shape of the rigid spherical body 152 depends on a needed pressure point to a muscle spasm or a myofascial tissue that is seeking relief. The rigid spherical body 152 may be disposed on a bendable sheet 154. In one embodiment, the bendable sheet 154 may be composed of a hard plastic. In another embodiment, the bendable sheet 154 may be composed of a hard rubber. The removable spherical pressure applicator 150 may consist of a nylon cover shaped in the form so that it may be inserted and removed relatively easily. The rigid spherical body 152 may be proximal to the user's body. The removable spherical pressure applicator 150 may come in varying sizes. The pouch 130 may be designed to receive the removable spherical pressure applicator 150.

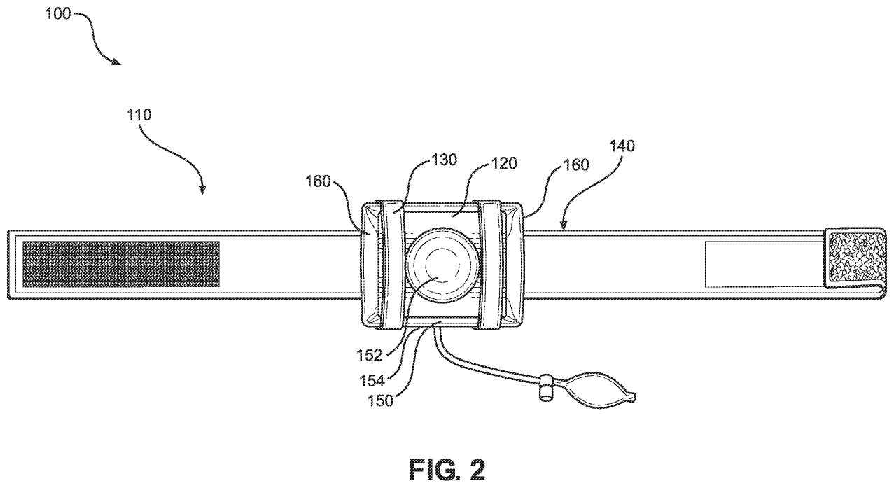

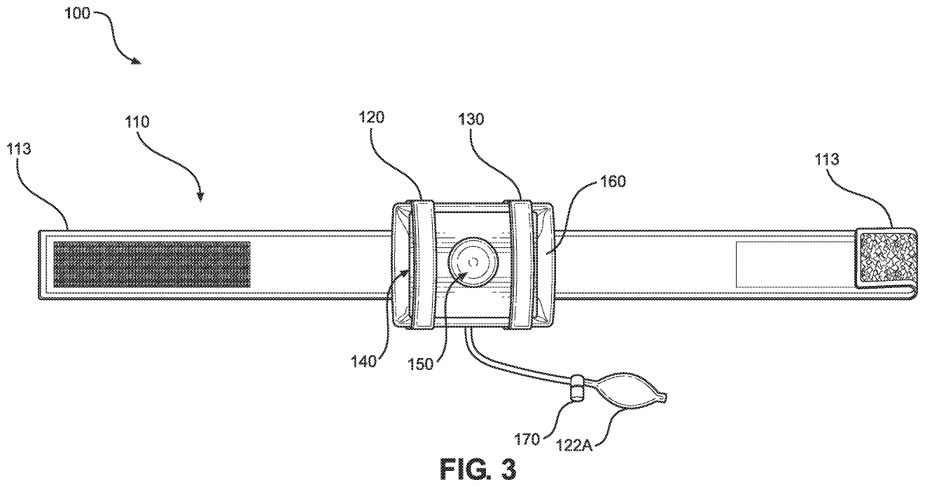

Referring now to FIGS. 2 and 3, there is shown a top view of an embodiment of an inflatable myofascial release device 100 and there is shown a top view of an alternative embodiment of an inflatable myofascial release device 100, respectively.

In operation, the user may insert the removable spherical pressure applicator 150 with a desired size or firmness of into the pouch 130. The user may then adapt to secure the elongated strap 110 around their body such that the elongated strap 110 may extend across an area where muscle release is desired. Specifically, the rigid spherical body 152 may be placed directly on a needed area of relief. A pair of stabilizer wings 160 may be located around the inflatable bladder 120. The pair of stabilizer wings 160 may create an equal pressure zone or the like.

The user may then activate the attached and squeezable hand pump 122 or the attached and squeezable foot pump 122A to inflate the inflatable bladder 120. Filling the inflatable bladder 120 with air causes it to expand and apply additional pressure to the removable spherical pressure applicator 150 against the user's body. When the inflatable bladder 120 inflates, the bendable sheet 154 will be pressed against the inflatable bladder 120 and conform to the inflatable bladder's 120 shape. The rigid spherical body 152 may protrude geometrically towards the place of emphasis on the user's body. The pressure of the rigid spherical body 152 may loosen the user's tissue and provide muscle relief. When completed with use, a knob 170 disposed on the attached and squeezable hand pump 152 or the attached and squeezable foot pump 152A will release the air and deflate the inflatable bladder 120 as desired.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An inflatable myofascial release device, comprising:
an elongated strap having a fastener disposed on each opposing end of the elongated strap;
an inflatable bladder centrally positioned on the elongated strap;
a pouch disposed adjacent to the inflatable bladder;
a pair of ancillary straps running perpendicular to the elongated strap, the pair of ancillary straps include a first ancillary strap and a second ancillary strap that create pressure around the inflatable bladder; and
a removable spherical pressure applicator composed of a rigid spherical body and a bendable sheet;
wherein the pouch receives and contains the removable spherical pressure applicator.

2. The inflatable myofascial release device, according to claim 1, wherein the fastener is a hook and loop fastener disposed on opposing ends of the elongated strap that is adapted to selectively engage and disengage about a user's body.

3. The inflatable myofascial release device, according to claim 2, wherein the fastener is adapted to allow the elongated strap to be adjustably secured around a desired area of the user's body.

4. The inflatable myofascial release device, according to claim 2, wherein filling the inflatable bladder with air causes it to expand and apply additional pressure to the removable spherical pressure applicator against the user's body.

5. The inflatable myofascial release device, according to claim 2, wherein the elongated strap extends around the user's body such that the elongated strap extends across an area where muscle release is desired.

6. The inflatable myofascial release device, according to claim 2, wherein the rigid spherical body is adapted to be proximal to the user's body.

7. The inflatable myofascial release device, according to claim 1, wherein the inflatable bladder includes an attached and squeezable hand pump to inflate the inflatable bladder.

8. The inflatable myofascial release device, according to claim 7, wherein the attached and squeezable hand pump is activated to inflate the inflatable bladder.

9. The inflatable myofascial release device, according to claim 1, further comprising a pair of stabilizer wings located around the inflatable bladder to create an equal pressure zone.

10. The inflatable myofascial release device, according to claim 1, wherein the pair of ancillary straps secure the inflatable bladder in a desired location to create pressure around the inflatable bladder and secure the inflatable bladder in the desired location.

11. The inflatable myofascial release device, according to claim 1, wherein the first ancillary strap is disposed across a first side of the inflatable bladder.

12. The inflatable myofascial release device, according to claim 1, wherein the second ancillary strap is disposed across a second side of the inflatable bladder.

13. The inflatable myofascial release device, according to claim 1, wherein the bendable sheet is composed of a hard plastic.

14. The inflatable myofascial release device, according to claim 1, wherein the bendable sheet is composed of a hard rubber.

15. The inflatable myofascial release device, according to claim 1, wherein the removable spherical pressure applicator includes a nylon cover shaped to be easily inserted and removed easily into the pouch.

16. The inflatable myofascial release device, according to claim 1, wherein the removable spherical pressure applicator includes a desired size or firmness.

17. The inflatable myofascial release device, according to claim 1, wherein the inflatable bladder inflates and the bendable sheet will be pressed against the inflatable bladder and conforms to the inflatable bladder's shape.

18. The inflatable myofascial release device, according to claim 1, wherein the rigid spherical body protrudes geometrically towards the user's body to loosen a user's tissue and provide muscle relief.

19. The inflatable myofascial release device, according to claim 1, wherein the rigid spherical body is centered and disposed on the bendable sheet.

20. The inflatable myofascial release device, according to claim 1, further comprising a knob disposed on the attached and squeezable hand pump that will release air within the inflatable bladder and deflate the inflatable bladder.
